(19) United States
(12) Patent Application Publication
(10) Pub. No.: US 2019/0275655 A1
(43) Pub. Date: Sep. 12, 2019

(54) CONCRETE FORM REMOVAL ASSEMBLY

(71) Applicant: Dale Rosentreter, Redmond, WA (US)

(72) Inventor: Dale Rosentreter, Redmond, WA (US)

(21) Appl. No.: 15/914,303

(22) Filed: Mar. 7, 2018

(51) Int. Cl. B25D 3/00; E04G 19/00; B25G 1/10

(52) U.S. Cl. CPC B25D 3/00; E04G 15/061; B25G 1/102; E04G 19/00

(57) ABSTRACT

A concrete form removal assembly for removing a sleeve from a concrete slab includes a sleeve. The sleeve is embedded in a concrete slab for defining an opening extending through the concrete slab when the concrete slab is poured. A cutting unit is provided that has a cutting end and a striking end. The cutting end is positioned on the sleeve and the striking end is struck with a driving tool. Thus, the cutting end is urged to cut through the sleeve for removing the sleeve from the concrete slab.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to removal devices and more particularly pertains to a new removal device for removing a sleeve from a concrete slab.

### BRIEF SUMMARY OF THE INVENTION

An embodiment of the disclosure meets the needs presented above by generally comprising a sleeve. The sleeve is embedded in a concrete slab for defining an opening extending through the concrete slab when the concrete slab is poured. A cutting unit is provided that has a cutting end and a striking end. The cutting end is positioned on the sleeve and the striking end is struck with a driving tool. Thus, the cutting end is urged to cut through the sleeve for removing the sleeve from the concrete slab.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are spooned out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a cutting unit of a concrete form removal assembly according to an embodiment of the disclosure.

FIG. 2 is a front view of a cutting unit of an embodiment of the disclosure.

FIG. 3 is a right side view of a cutting unit of an embodiment of the disclosure.

FIG. 4 is a perspective in-use view of an embodiment of the disclosure.

### DETAILED DESCRIPTION OF THE INVENTION

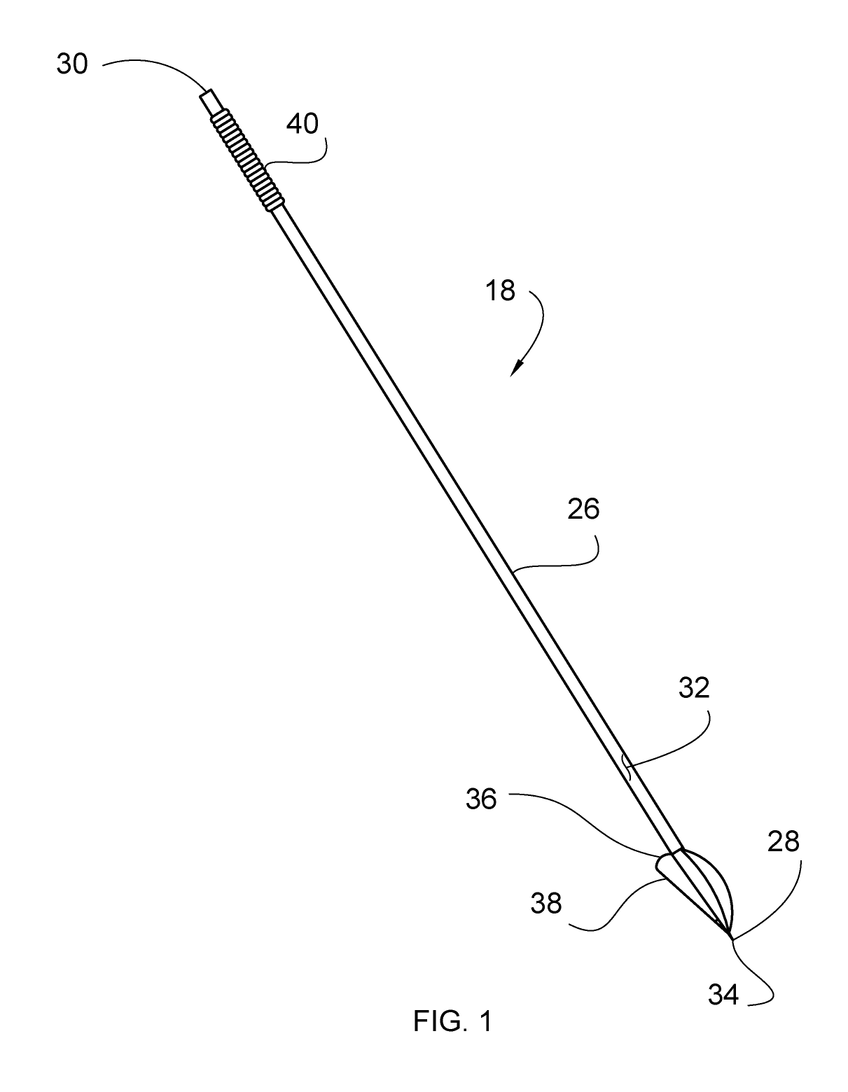

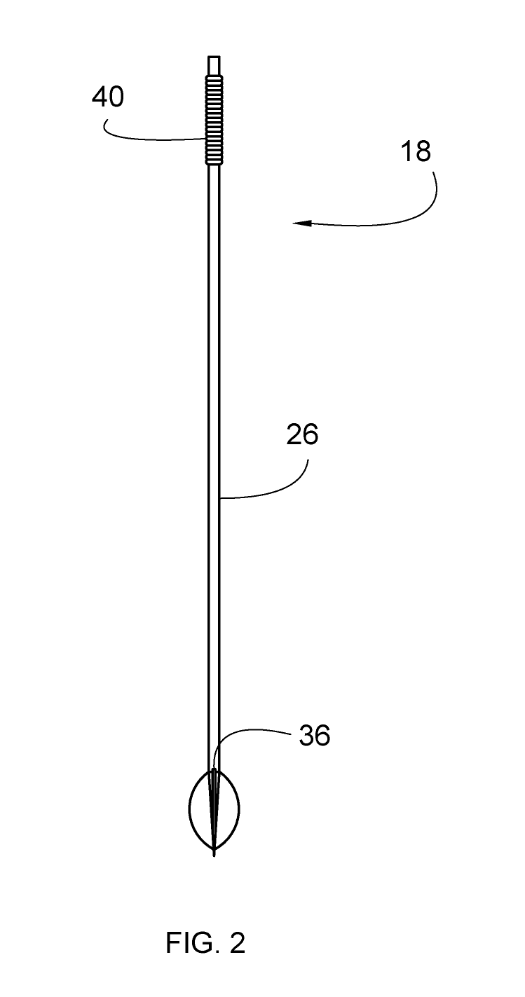

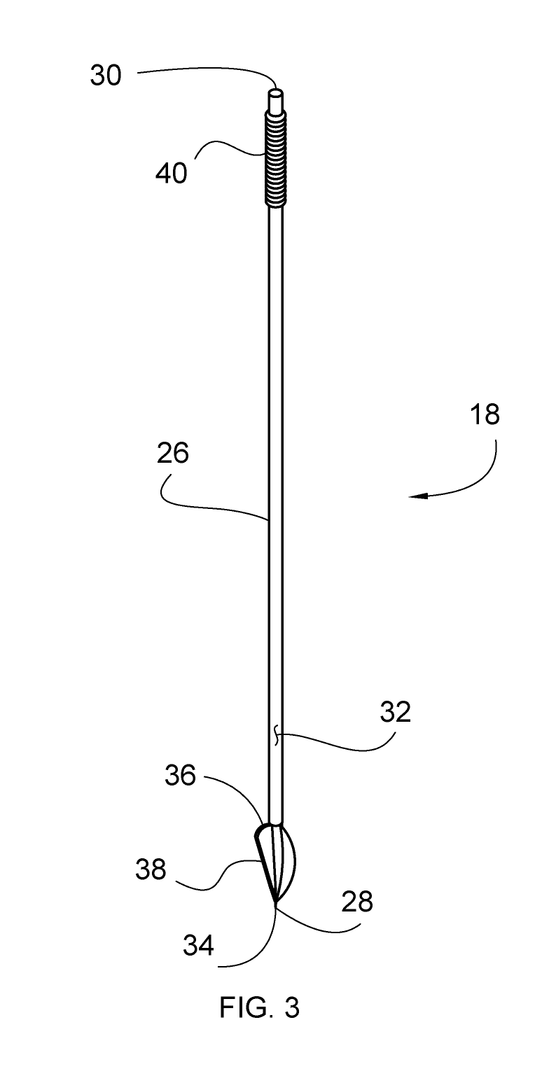

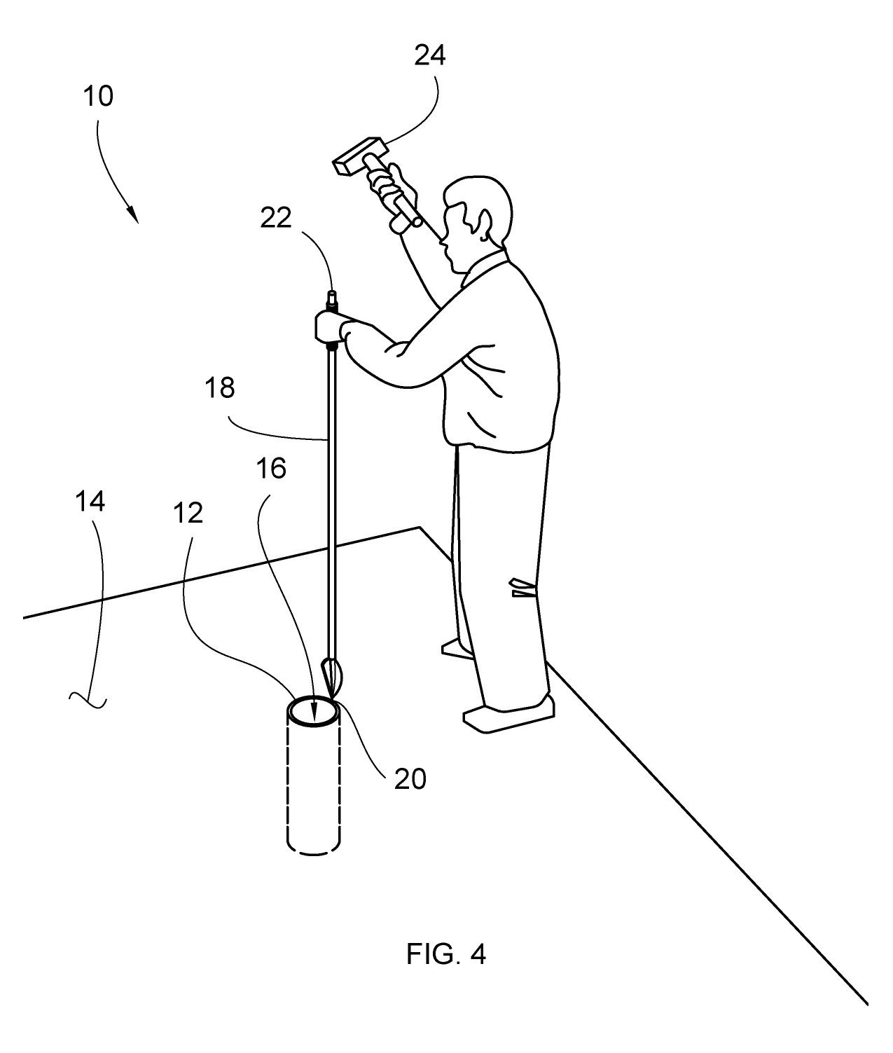

With reference now to the drawings, and in particular to FIGS. 1 through 4 thereof, a new removal device embodying the principles and concepts of an embodiment of the disclosure and generally designated by the reference numeral 10 will be described.

As best illustrated in FIGS. 1 through 4, the concrete form removal assembly 10 generally comprises a sleeve 12. The sleeve is embedded in a concrete slab 14 for defining an opening 16 extending through the concrete slab 14 when the concrete slab is formed. The concrete slab 14 may be a floor or a wall in a building and the opening 16 may be formed for the purposes of routing plumbing through the concrete slab 14. The sleeve 12 may be comprised of pvc or other rigid material that can be cut with a hand operated saw. Additionally, the sleeve 12 must be removed from the opening 16 prior to routing plumbing through the opening 16.

A cutting unit 18 is provided that has a cutting end 20 and a striking end 22. The cutting end 20 is positioned on the sleeve 12 and the striking end 22 is struck with a driving tool 24, such as a hammer or the like. Thus, the cutting end 20 is urged to cut through the sleeve 12 for removing the sleeve 12 from the concrete slab 14. In this way the opening 16 in the concrete slab 14 is cleared for routing the plumbing through the opening 16.

The cutting unit 18 comprises a rod 26 that has a first end 28, a second end 30 and an outer surface 32 extending therebetween. The rod 26 is elongated between the first end 28 and the second end 30 and the rod 26 may have a length of at least 1.0 meter. The outer surface 32 flares outwardly in opposite directions with respect to a center line of the rod 26 to define a spoon 34 adjacent to the first end 28. Additionally, the spoon 34 may be concavely arcuate with respect to the center line thereby facilitating the spoon 34 to conform to the curvature of the sleeve 12. The first end 28 is positionable at an intersection between the sleeve 12 and the concrete. The second end 30 is struck by the driving tool 24 to drive the spoon 34 downwardly between the sleeve 12 and the concrete.

A blade 36 is coupled to and extends outwardly from the outer surface 32. The blade 36 has a distal edge 38 with respect to the outer surface 32 and the distal edge 38 is sharpened to cut through the sleeve 12 when the second end 30 is struck. The blade 36 extends upwardly from the spoon 34 towards the second end 30 and the distal edge 38 angles outwardly from the spoon 34. A grip 40 is coupled around the rod 26 and the grip 40 is spaced from the second end 30. The grip 40 is comprised of a resiliently compressible material to enhance gripping the rod 26.

In use, the spoon 34 is positioned between the sleeve 12 and the concrete slab 14. The second end 30 of the rod 26 is struck with the driving tool 24 thereby urging the blade 36 to cut through the sleeve 12. Moreover, the second end 30 is repeatedly struck to drive the blade 36 through the entire length of the sleeve 12 thereby facilitating the sleeve 12 to be collapsed in the opening 16. The spoon 34 urges the sleeve 12 away from the concrete 14 when the blade 36 is driven downwardly through the sleeve 12. In this manner the sleeve 12 can be removed from the opening 16 thereby facilitating plumbing to be routed through the opening 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A concrete form removal assembly being configured to remove a form from a concrete slab, said assembly comprising:
a sleeve being configured to be embedded in a concrete slab for defining an opening extending through the concrete slab; and
a cutting unit having a cutting end and a striking end, said cutting end being positioned on said sleeve, said striking end being struck with a driving tool such that said cutting end is urged to cut through said sleeve for removing said sleeve from the concrete slab.

2. The assembly according to claim 1, wherein said cutting unit comprises a rod having a first end, a second end and an outer surface extending therebetween, said rod being elongated between said first end and said second end, said outer surface flaring outwardly in opposite directions with respect to a center line of said rod to define a spoon adjacent to said first end, said first end being positionable at an intersection between said sleeve and the concrete.

3. The assembly according to claim 2, further comprising a blade being coupled to and extending outwardly from said outer surface, said blade having a distal edge with respect to said outer surface, said distal edge being sharpened such that said distal edge cuts through said sleeve when said second end is struck.

4. The assembly according to claim 3, wherein said blade extends upwardly from said first end towards said second end, said distal edge angling outwardly from said first end.

5. The assembly according to claim 2, further comprising a grip being coupled around said rod wherein said grip is configured to be gripped, said grip being spaced from said second end, said grip being comprised of a resiliently compressible material wherein said grip is configured to enhance gripping said rod.

6. A concrete form removal assembly being configured to remove a form from a concrete slab, said assembly comprising:
a sleeve being configured to be embedded in a concrete slab for defining an opening extending through the concrete slab; and
a cutting unit having a cutting end and a striking end, said cutting end being positioned on said sleeve, said striking end being struck with a driving tool such that said cutting end is urged to cut through said sleeve for removing said sleeve from the concrete slab, said cutting unit comprising:
a rod having a first end, a second end and an outer surface extending therebetween, said rod being elongated between said first end and said second end, said outer surface flaring outwardly in opposite directions with respect to a center line of said rod to define a spoon adjacent to said first end, said spoon being positioned between an intersection of said sleeve and the concrete, said first end being positionable at an intersection between said sleeve and the concrete, said second end being configured to be struck by the driving tool;
a blade being coupled to and extending outwardly from said outer surface, said blade having a distal edge with respect to said outer surface, said distal edge being sharpened such that said distal edge cuts through said sleeve when said second end is struck, said blade extending upwardly from said first end towards said second end, said distal edge angling outwardly from said first end; and
a grip being coupled around said rod wherein said grip is configured to be gripped, said grip being spaced from said second end, said grip being comprised of a resiliently compressible material wherein said grip is configured to enhance gripping said rod.
